(19) United States
(12) Patent Application Publication
(10) Pub. No.: US 2014/0139921 A1
(43) Pub. Date: May 22, 2014

(54) TIME DISPERSION COMPENSATING DEVICE APPLIED TO THE GENERATION OF ULTRA-SHORT LIGHT PULSES

(71) Applicant: FASTLITE, Valbonne (FR)

(72) Inventors: Pierre TOURNOIS, Caches S/MER (FR); Nicolas FORGET, Orsay (FR)

(73) Assignee: FASTLITE, Valbonne (FR)

(21) Appl. No.: 14/078,721

(22) Filed: Nov. 13, 2013

(30) Foreign Application Priority Data
Nov. 19, 2012 (FR) 12 60980

(51) Int. Cl. G02B 5/18

(52) U.S. Cl. CPC G02B 5/1814
USPC 359/569

(57) ABSTRACT

A device for compensating time dispersions applied to the generation of ultra-short pulses, includes: two transparent optical diffraction gratings (RA, RB), which are identical and parallel to each other, operating on the principle of the Bragg diffraction, and two identical prisms (PA, PB), placed head to tail, in the space separating the optical diffraction gratings (RA, RB), knowing that the outer faces (FeA, FeB) of the prisms are parallel to each other and form a non-zero angle (γ) with the faces of the optical diffraction gratings.

The present invention relates to a device for compensating time dispersion applied to the generation of ultra-short pulses.

This device in particular applies to systems for generating ultra-short light pulses requiring compensation of the time dispersion of the optical frequencies introduced by the various components of the generating channel.

In general, it is known that systems for generating ultra-short light pulses with lengths shorter than or equal to 10 fs must transmit optical frequency bands of approximately 100 THz, or expressed in optical wavelengths, approximately 200 nm around its central wavelength of 800 nm. The most significant difficulty encountered in such systems is compensating the time dispersion of the optical frequencies introduced by the optical components and systems.

The dispersion in the optical systems is expressed by the variation of the optical phase φ as a function of the optical pulse: ω=2πν, using the following Taylor series:

φ(ω)=φ₀+φ₁(ω−ω₀)+φ₂(ω−ω₀)²/2+φ₃(ω−ω₀)³/6+φ₄(ω−ω₀)⁴/24+φ₅(ω−ω₀)⁵/5!+ . . .

ν being the optical frequency taken around a central frequency ν₀ of the pulsation ω₀.

The group delay is then given by:

t_{g}(ω)=t₀+φ₂(ω−ω₀)+φ₃(ω−ω₀)²/2+φ₄(ω−ω₀)³/6+φ₅(ω−ω₀)⁴/24+ . . .

The 1^{st} order dispersions (term in φ₂) and 2^{nd} order dispersions (term in φ₃) of the variation of the group delay with the optical frequency, which are introduced by the elements of the laser amplification chain, may be compensated by a pair of “GRISMS” (contraction of “grating” and “prism”), as introduced in Patent no. 09 58840 filed in France on Dec. 10, 2009, and covered in the publication by N. Forget, V. Crozatier and P. Tournois in Applied Physics B (2012, vol. 109, pp. 121-125): “Transmission Bragg-grating Grisms for Pulse Compression”.

In the description of the aforementioned patent and that of the aforementioned publication, the faces of the gratings and the outer faces of the prisms are parallel, which does not make it possible to compensate the 3^{rd} order dispersion (term in φ₄) of the variation of the delay with the optical frequency.

In these systems, in order to bypass the instantaneous optical power limitations in the amplifiers, the light pulse is first temporally extended by a second order dispersion device in phase φ₂ with a given sign, called stretcher, then amplified and ultimately recompressed by a second order dispersion device in phase φ₂ with an opposite sign, called compressor, often done by a combination of two parallel gratings like those described by E. B. Treacy in IEEE J. on Quantum Electron. (5, 9, pp. 454-458, September 1969): “Optical Pulse Compression with Diffraction Gratings”.

However, such a compressor device generally introduces a positive 2^{nd} order dispersion (term in φ₃), which, in the Treacy system, is added to the dispersion of the materials. These devices are therefore only appropriate when the spectral band is weak enough for the effect of the 2^{nd} order (term in φ₃) and higher order (term in φ₄, φ₅) terms to be considered negligible.

That is why the devices, called “GRISMS”, which are hybrid devices integrating two identical prisms, mounted head to tail, placed inside two parallel gratings and operating either in reflection, like those described in the publications: “Efficient reflection grisms for pulse compression and dispersion compensation of femtosecond pulses” (Optics Letters, November 2006, pp. 3363-3365), “Dispersion management for sub-10 fs, 10TW optical parametric chirped-pulse amplifier” (Optics Letters, August 2007, pp. 2227-2229), “Design considerations for a compact grism stretcher for non-collinear optical parametric chirped-pulse amplification” Appl. Phys. B, 2009, pp. 445-452), or in transmission, like those in the aforementioned Patent no. 09 58840, whereof the outer faces of the prisms are parallel to the faces of the gratings and which make it possible to obtain a 1^{st} order (term in φ₂) dispersion without 2^{nd} order (term in φ₃) dispersion, or with a 2^{nd} order dispersion whereof the sign is adjustable to compensate the dispersions of optical systems, are used. However, none of these devices, whereof all of the outer faces are parallel, makes it possible to compensate the 3^{rd} order dispersion (term in φ₄).

The aim of the invention is to propose a device making it possible to compensate the third order time dispersions.

The invention relates to a device for compensating time dispersions applied to the generation of ultra-short pulses, comprising:
two transparent optical diffraction gratings, which are identical and parallel to each other, operating on the principle of the Bragg diffraction, and
two identical prisms, placed head to tail, in the space separating said aforementioned optical diffraction gratings,

knowing that the outer faces of said aforementioned prisms are parallel to each other and form a non-zero angle with the faces of said aforementioned optical diffraction gratings.

One additional parameter, defining said aforementioned non-zero angle, called γ, makes it possible to compensate the 3^{rd} order dispersion (term in φ₄) of the variation of the delay with the optical frequency, in addition to those of the 1^{st} and 2^{nd} orders.

Advantageously, the device according to the invention may be applied to producing ultra-short pulse amplifiers using the principle of stretching and recompression.

Another considered application of the proposed device relates to acousto-optic diffraction-based programmable filters. These filters are made from a material, such as Paratellurite, whereof the specific dispersion is added to the scheduled dispersion produced by the acousto-optic interaction. Adding a device according to the invention makes it possible to completely or partially compensate this specific dispersion, which makes it possible to extend the use of the filters to higher bandwidths.

One embodiment of a device according to the invention is described below, as a non-limiting example, in reference to the appended drawings, in which:

FIG. 1 is a diagrammatic illustration of the structure of a device according to the invention;

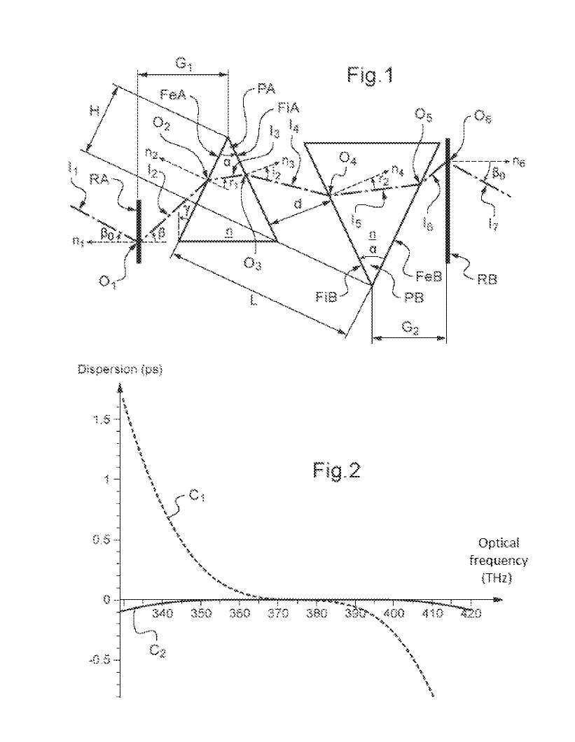

FIG. 2 is a diagrammatic illustration of dispersion results obtained owing to the device of FIG. 1;

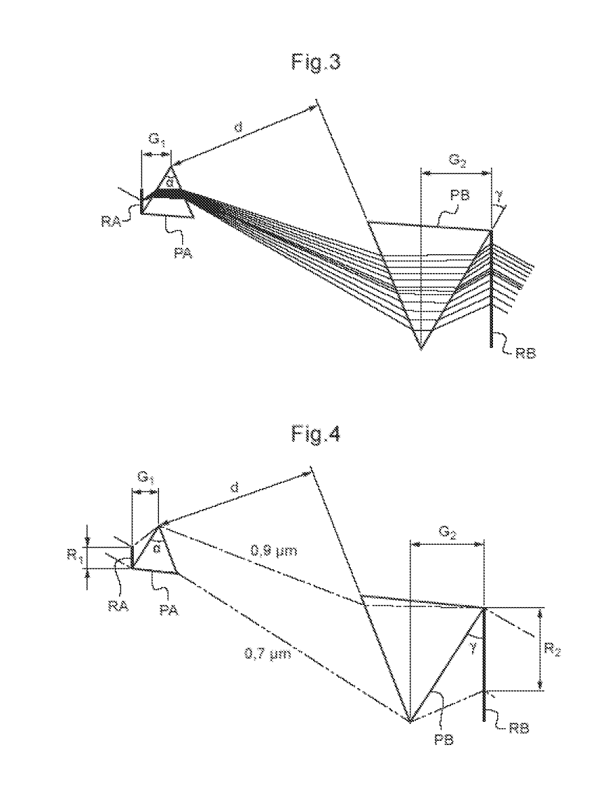

FIG. 3 shows the outline of the optical rays inside the device of FIG. 1;

FIG. 4 shows the outline of the extreme rays in the device of FIG. 1;

FIG. 5 shows the residue of the 4^{th} order of the uncorrected delay according to a first embodiment of the invention; and

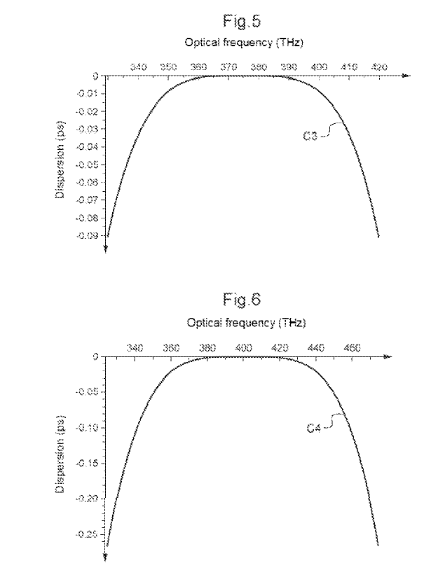

FIG. 6 shows the 4^{th} order residue of the uncorrected delay according to a second embodiment of the invention.

In the example shown in FIG. 1, the diagrammatic illustration of a first embodiment of a structure of a device according to the invention for compensating the time dispersion applied to the generation of ultra-short light pulses, comprises two Bragg gratings RA, RB, which are identical and parallel to each other, comprising a number of lines σ per mm, between which are placed, in so-called head-to-tail geometry, two identical prisms PA, PB, with index n, with apical angle α, whereof the outer faces FeA and FeB, respectively, are parallel to each other, separated by a length L and form an angle γ with the parallel faces of the gratings RA and RB. The distance between the apices of the prisms PA, PB, measured parallel to the faces FeA and FeB, is H, and the distance between the two inner faces FiA and FiB of the prisms is d.

A first incident optical beam I₁ is shown in FIG. 1; this beam I₁ penetrates the grating RA at a point O₁ under the Bragg incidence β₀ relative to the normal n₁ to the grating RA, given by:

sin β₀=−σc/2ν₀

c being the speed of the light in the vacuum, and ν₀ the central optical frequency of the chosen band.

The optical index n of the prisms PA, PB is chosen such that the order 0, not diffracted, is completely reflected by the inner face FiA of a first prism PA. Order 1 is diffracted in the air toward the apex of the first prism PA, shown by a second optical beam I₂, under a positive angle β such that:

$$sin β = σ c ( \frac{1}{v} - \frac{1}{2 {v}_{0}} )$$

which is refracted in the glass, along a third beam I₃, by the outer face FeA of the first prism PA at a point O₂, under an angle r₁, such that:

sin r₁=sin(β+γ)/n

the angle (β+γ) being the angle formed by the diffracted beam I₂ with the normal n₂ to the inclined face FeA.

The third beam I₃ is then refracted in the air along a fourth beam I₄ by the inner face FiA of the first prism PA under an angle i₂, such that:

sin i₂=n sin(r₁−α)

the angle (r₁−α) being the angle formed by the beam I₃ with the normal n₃ to the inner face FiA of the prism PA.

The distance d between the two inner faces FiA, FiB, respectively, of the prisms PA, PB, is:

d=(L cos α−H sin α)

The fourth beam I₄ travels in the air for a distance d/cos i₂ , to arrive at point O₄ on the inner face FiB of the second prism PB, then is refracted in the glass by the prism PB, along a fifth beam I₅, under the angle r₂=(r₁−α), to arrive at a point O₅ on the outer face FeB of the second prism PB. The fifth beam I₅ is then refracted in the air along a sixth beam I₆ by the outer face FeB of the second prism PB under the angle (β+γ) to arrive at the point O₆ on the second grating RB under the angle β, and to be diffracted along a seventh beam I₇, parallel to the incident beam I₁, under the angle β₀ relative to the normal n₆ to the grating RB.

The optical group index of the prisms being N, the group delay t_{g} introduced by the device between an input wave plane passing through the apex of the first prism PA and an output wave plane passing through the apex of the second prism PD is given by:

$${ct}_{g} = \frac{d}{cos {i}_{2}} + \frac{1}{cos {r}_{1}} ⌊ L - \frac{d cos ( α + {i}_{2} )}{cos {i}_{2}} ⌋ [ N - \frac{cos {r}_{2} ( sin γ + sin {β}_{0} cos ( β + γ )}{sin α sin β} ] + ( {G}_{1} + {G}_{2} ) \frac{( 1 - cos ( β - {β}_{0} ) )}{cos β}$$

G₁ and G₂ respectively being the distances from the apex of the first prism PA to the first grating RA and from the apex of the second prism PB to the second grating RB.

In the example shown in FIG. 2, the curves C1, C2 illustrate the interest of the incline of the prisms within the Bragg diffraction gratings in the example where the device compensates the dispersion of a silica fiber 75 cm long in a band of 200 nm around 800 nm, i.e., from 330 to 420 THz.

Curve C1 shows the uncorrected dispersion of the 3^{rd} order that is residual, after correction of the 1^{st} and 2^{nd} orders by a device according to said aforementioned Patent no. 09 58840, in which the prisms are not inclined inside the gratings.

Curve C2 shows the uncorrected dispersion of the 4^{th} order that is residual, after correction of the 1^{st}, 2^{nd} and 3^{rd} orders by the device according to the invention.

The residual dispersion is 30 times lower in the case of inclined prisms (from 3 ps to 100 fs).

In the example shown in FIG. 3, the optical rays are indicated inside the device according to the invention for a given incidence radius over the first optical grating and in a bandwidth of 200 nm on either side of 800 nm.

In the example shown in FIG. 4, the extreme optical rays are indicated inside the device according to the invention for a bandwidth of 200 nm on either side of 800 nm.

We will now describe a first embodiment of the invention, the dispersion of which is illustrated by FIG. 5.

As a first example of a device for compensating the time dispersion according to the invention, this involves compensating the time dispersion of 95 ps introduced by a silica fiber structure whereof the length of the optical path is L₀=75 cm in a band of 200 nm on either side of λ₀=0.8 μm, i.e., 90 THz on either side of ν₀=375 THz, by a pair of inclined “GRISMS” used in back-and-forth and made up of two gratings of σ=1250 lines/mm and two SF 57 glass prisms, whereof the group index is N₀.

The Taylor expansion of the delay introduced by this stretcher: t_{R}=N₀L₀/c, as a function of the optical frequency ν around ν₀, is written:

t_{R}=4691.3+1.052(ν−375)+2.088.10⁻³(ν−375)²+1.557.10⁻⁶(ν−375)³+3.828.10⁻⁹(ν−375)⁴+++

The Taylor expansion of the delay t_{g} introduced by the pair of inclined “GRISMS” is written:

t_{g}=t₀+C₂(ν−375)+C₃(ν−375)²+C₄(ν−375)³+C₅(ν−375)⁴+++

C₂, C₃, C₄ and C₅ being the Taylor coefficients of orders 1, 2, 3 and 4 of the delay t_{g}.

To compensate, to the 4^{th} order, the time dispersion of 95 ps of the structure, by the pair of inclined “GRISMS” used in back-and-forth, it is necessary to solve the system of equations:

C₂+(1.052)/2=0, C₃+(2.088.10⁻³)/2=0 and C₄+(1.557.10⁻⁶)/2=0

For a diameter D₁=4 mm of the incident beam on the grating RA, the solution to the system of equations is:
α=54.978°, δ=38.815°, L=85.36 mm, H=8.54 mm and d=42 mm with: R₁=4.69 mm, R₂=19.40 mm, G₁=11.23 mm and G₂=23.78 mm,

R₁ and R₂ representing the length of the gratings RA and RB.

The uncorrected 4^{th} order residue of the delay (term in φ₅) is shown in FIG. 5 along curve C3.

This residue is 30 times lower than the 3^{rd} order residue not corrected by the straight “GRISMS” according to the description of the aforementioned Patent no. 09 58840.

We will now describe a second embodiment of the invention, the dispersion of which is illustrated by FIG. 6.

As a second example of a device for compensating the time dispersion with a very wide band, according to the invention, the aim is to compensate the time dispersion of a TeO₂ crystal whereof the group index is N₁ and the length L₁=45 mm, which constitutes the acoust-optic head of a AOPDF (Acousto-Optic Programmable Dispersive Filter), in a band of 300 nm around the optical frequency ν₀ of 400 THz (λ₀=0.75 μm), i.e., from 325 to 475 THz, by a pair of inclined GRISMS used one way and made up of two gratings of σ=966 lines/mm and two SF 57 glass prisms.

The Taylor expansion of the delay introduced by the TeO₂ crystal: t_{R}=N₁L₁/c as a function of the optical frequency ν around ν₀, is written:

t_{R}=353.6+1.550.10⁻¹(ν−400)+3.183.10⁻⁴(ν−400)²+4.050.10⁻⁷(ν−400)³+6.964.10⁻¹⁰(ν−400)⁴+++

If one pre-programs, in the AOPDF, a linear frequency variation ν of 15000 fs² around 400 THz, i.e.: 9.425.10⁻²(ν−400), the Taylor expansion of the delay introduced by the AOPDF filter becomes:

t_{R}=353.6+2.492.10⁻¹(ν−400)+3.183.10⁻⁴(ν−400)²+4.050.10⁻⁷(ν−400)³+6.964.10⁻¹⁰(ν−400)⁴+++

To compensate the time dispersion of the AOPDF filter up to the 4^{th} order using the pair of inclined “GRISMS” used one way, it is necessary to solve the system of equations:

C₂+2.492.10⁻¹=0, C₃+3.183.10⁻⁴=0 and C₄+4.050.10⁻⁷=0

For a diameter D₁=3 mm of the incident beam on the grating RA, the solution of the system of equations is:
α=54.261°, γ=43.804°, L=77.23 mm, H=8.50 mm and d=38.21 mm with: R₁=3.35 mm, R₂=19.16 mm, G₁=7.76 mm and G₂=24.35 mm,

R₁ and R₂ representing the length of the gratings RA and RB.

The uncorrected 4^{th} order residue of the delay (term in φ₅) is shown in FIG. 6 along curve C4.

As a third example of a device for compensating the time dispersion, this involves associating a first device according to the invention and a second device according to the invention, the second device being oriented at 180° relative to the first device, making it possible to double the dispersion effects and recover the initial geometry of the optical beam.

1. A device for compensating time dispersions applied to the generation of ultra-short pulses with optic frequency (ν), comprising:
two transparent optical diffraction gratings (RA, RB), which are identical and parallel to each other, operating on the principle of the Bragg diffraction, and
two identical prisms (PA, PB), placed head to tail, in the space separating said aforementioned optical diffraction gratings (RA, RB),
characterized in that the outer faces (FeA, FeB) of said aforementioned prisms (PA, PB) are parallel to each other and form a non-zero angle (γ) with the faces of said aforementioned optical diffraction gratings (RA, RB).

2. The device according to claim 1, characterized in that it introduces a group delay time (t_{g}) whereof the variation as a function of the optical frequency (ν) compensates the variation of a group delay time (t_{R}) introduced by one or the group of the elements of an optical channel up to the 4^{th} order of the Taylor series of said delay time (t_{R}).

3. A time dispersion compensating device, characterized in that it comprises a first device according to claim 2 and a second device, the second device being oriented at 180° relative to the first device.

4. A method for compressing laser pulses previously stretched by a dispersive optical device, characterized in that it uses a device according to claim 1.

5. A method for compensating the time dispersion of an acousto-optic filter, which may or may not be programmable, characterized in that it illustrates a device according to claim 1.

6. A method for compressing laser pulses previously stretched by a dispersive optical device, characterized in that it uses a device according to claim 2.

7. A method for compressing laser pulses previously stretched by a dispersive optical device, characterized in that it uses a device according to claim 3.

8. A method for compensating the time dispersion of an acousto-optic filter, which may or may not be programmable, characterized in that it illustrates a device according to claim 2.

9. A method for compensating the time dispersion of an acousto-optic filter, which may or may not be programmable, characterized in that it illustrates a device according to claim 3.
